(19) United States
(12) Patent Application Publication
(10) Pub. No.: US 2022/0016744 A1
(43) Pub. Date: Jan. 20, 2022

(54) PROCESSING DEVICE AND METHOD FOR PROCESSING A MATERIAL

(71) Applicant: VOLKSWAGEN AKTIENGESELLSCHAFT, Wolfsburg (DE)

(72) Inventors: Sven Rathmann, Braunschweig (DE); Alexander Breuer, Celle (DE); Dennis Böhm, Wolfenbüttel (DE)

(73) Assignee: VOLKSWAGEN AKTIENGESELLSCHAFT, Wolfsburg (DE)

(21) Appl. No.: 17/378,077

(22) Filed: Jul. 16, 2021

(30) Foreign Application Priority Data
Jul. 17, 2020 (DE) 10 2020 118 973.7

(51) Int. Cl. B24C 5/04; B24C 1/04; B24C 9/00

(52) U.S. Cl. CPC B24C 5/04; B24C 9/00; B24C 1/045

(57) ABSTRACT

A processing device for processing a material with a focused blasting medium, having at least a blasting medium source for generating the blasting medium and a conveying device for the material, or additionally a deflecting means for deflecting the blasting medium emitted by the blasting medium source toward the material; wherein the conveying device is arranged opposite the blasting medium source or the deflecting means in such a way that the material, at least with a region to be processed by the blasting medium, can be processed by the conveying device on a circular path opposite the blasting medium source or the deflecting means, so that the material, when the blasting medium source or the deflecting means is moved, can be processed along the circular path with a constant focus position of the blasting medium. A method for processing a material with a focused blasting medium in a processing device.

### CROSS REFERENCE TO RELATED APPLICATION

This application claims priority to German Patent Application No. 10 2020 118 973.7, filed Jul. 17, 2020, which is hereby incorporated by reference in its entirety.

### FIELD OF THE INVENTION

The invention relates to a processing device and a method for processing a material with a processing device.

### BACKGROUND OF THE INVENTION

Batteries, in particular lithium-ion batteries, are increasingly being used to drive motor vehicles. Batteries are typically composed of cells, wherein each cell has a stack of anode, cathode and separator sheets. The anode and cathode sheets are hereinafter referred to as electrode sheets.

The electrode sheets are usually produced by punching or cutting, e.g. laser cutting.

Particularly when cutting, high process speeds can be achieved in the production of the electrode sheets from a continuous material (coil).

In order to generate transverse cuts in particular, that is to say transversely to a conveying direction of the continuous material, by means of laser cutting, the laser beam source or the deflecting means used to deflect the laser beam must be moved relative to the conveying device. In order to produce cut edges that are as rectangular as possible, at least one two-axis movement parallel to the conveying plane of the continuous material is required. The laser beam source or the deflecting means must be moved back to a starting position after each processing step,

From DE 37 07 665 A1 a method and device for splitting leather by means of a laser beam are known.

A device for laser cutting is known from CN 2774693 Y, in which a laser beam is deflected onto a material via a polygon-like deflecting means.

The object of the present invention is to at least partially solve the problems set forth with reference to the prior art. In particular, a processing device and a method for processing a material with a processing device are to be proposed. A high process speed and, in particular, right-angled cutting edges when cutting material should be made possible.

### SUMMARY OF THE INVENTION

A device as claimed and a method as claimed contribute to achieving these objects. Advantageous refinements are the subject matter of the dependent claims. The features listed individually in the claims can be combined with one another in a technologically sensible manner and can be supplemented by explanatory facts from the description and/or details from the figures, in which further variants of embodiments of the invention are shown.

A processing device for processing a material with a focused blasting medium is proposed. The processing device comprises at least one blasting medium source for generating the blasting medium and a conveying device for the material. In addition, the processing device can comprise a deflecting means for deflecting the blasting medium emitted by the blasting medium source toward the material. The conveying device is arranged opposite the blasting medium source or the deflecting means in such a way that the material, at least with a region to be processed by the blasting medium, is arranged on a circular path by the conveying device opposite the blasting medium source or the deflecting means. The material can thus be processed along the circular path with a constant focus position of the blasting medium when the blasting medium source or the deflecting means is moved.

The blasting medium is in particular a laser beam. For processing the material, the blasting medium has, in particular, a focus position, that is to say a predetermined position of the focus with respect to the material. To ensure the most constant possible cutting quality, the focus position is to be maintained or set as uniformly as possible along at least one cutting course.

In particular, a continuous material is used as the material, from which electrode sheets are cut out with the processing device.

A focusing of the beam can be done with a laser beam, for example by optical focusing, for example by means of a lens or a reflective surface.

In particular, the blasting medium emerges from the blasting medium source and strikes the material. A focusing and/or a deflecting means can be arranged between the blasting medium source and the material. The deflecting means serves to deflect the blasting medium toward the material. The focusing can be arranged movably in the processing device. The focusing can also be used to deflect the blasting medium. In particular, the focusing can be used to adjust where the blasting medium strikes the deflecting means. In particular, a focus position on the material can also be changed in this way.

The material is in a predetermined region, e.g. along a line or on a surface. This region is arranged on a circular path opposite the blasting medium source or the deflecting means. The circular path has a center point or an axis of rotation to which the material is arranged along the region at a constant distance or radius. The arrangement of the material on a circular path enables the blasting medium to have a constant focus position relative to the material when the blasting medium source or the deflecting means is rotated about the center of the circular path or about the axis of rotation.

The region extends in particular over an angular range of at least 5 angular degrees, preferably of at least 25 angular degrees, particularly preferably of at least 60 angular degrees or even of at least 120 angular degrees. In particular, the region extends over an angular range of at most 180 angular degrees, preferably of at most 160 angular degrees.

The conveying device can comprise a multi-link conveyor belt or rollers which form a support for the material. The material can be arranged and fixed on the support by means of negative pressure, wherein the material is sucked through the support. Alternatively or additionally, the material can be pressed against the support with a pressing device. For this purpose, the material can be arranged between the support and a strip material forming the pressing device. The conveying device forms, in particular, a circular arc-shaped support for the material, via which the material is arranged on the circular path opposite the blasting medium source or the deflecting means.

In particular, an extraction system is provided which can extract smoke from the processing zone that is produced during processing of the material. The extraction is particularly necessary in the manufacture of electrode sheets.

In particular, the material can be moved by the conveying device along a conveying direction with respect to the blasting medium source or the deflecting means (or a stationary environment), in particular along the circular path or at right angles thereto.

In particular, the material can be held in a constant position during processing, i.e. when the blasting medium is coupled into the material, and only moved during breaks in processing, i.e. when the blasting medium is not coupled into the material, at a feed rate in relation to the blasting medium source or the deflecting means (or a stationary environment). As an alternative or in addition, the material can also be moved at a feed rate during processing relative to the blasting medium source or the deflecting means (or a stationary environment). In both cases, the blasting medium can be moved in relation to the material or a stationary environment. The focus position of the blasting medium remains constant in relation to the material.

In particular, the conveying direction of the material runs along the circular path or transversely to the course of the circular path.

In particular, by moving the blasting medium source or the deflecting means, the focus position of the blasting medium can be moved at least along the circular path and, if necessary, also transversely to the course of the circular path. The movement along the circular path is implemented in particular by a rotary movement of the blasting medium source or the deflecting means. The movement transverse to the course of the circular path is realized in particular by a transverse movement of the blasting medium source or the deflecting means. The movements along the circular path and transversely to the course of the circular path are in particular coupled to one another, that is to say are preferably carried out at least partially simultaneously.

Even with material moved along a conveying direction during processing, cut edges that run transversely to the conveying direction can be generated.

In particular, the processing device comprises the deflecting means and the deflecting means has a polygonal shape or a pyramid shape. In particular, the deflecting means is rotatably arranged. When the deflecting means is rotated about an axis of rotation that intersects the center point of the circular path, the focus position can be moved along the circular path with the blasting medium source in a constant position. If the deflecting means is moved transversely along the axis of rotation, this transverse movement can in particular be coupled with the rotary movement, so that cut edges running transversely to the conveying direction of the material can be produced.

A method is proposed for processing a material with a focused blasting medium in a processing device, in particular in the processing device described. The processing device comprises at least one blasting medium source for generating the blasting medium and a conveying device for the material. In addition, the processing device can comprise a deflecting means for deflecting the blasting medium emitted by the blasting medium source toward the material. The conveying device is arranged opposite the blasting medium source or the deflecting means in such a way that the material, at least with a region to be processed by the blasting medium, is arranged on a circular path by the conveying device opposite the blasting medium source or the deflecting means. The method comprises at least the following steps:

a) Placing the material in the conveying device;

b) Processing of the material with the blasting medium, wherein the material is processed along the circular path with a constant focus position of the blasting medium.

In particular, the material can be held in a constant position during processing, i.e. when the blasting medium is coupled into the material, and only moved during breaks in processing, i.e. when the blasting medium is not coupled into the material, at a feed rate in relation to the blasting medium source or the deflecting means (or a stationary environment). As an alternative or in addition, the material can also be moved at a feed rate during processing relative to the blasting medium source or the deflecting means (or a stationary environment). In both cases, the blasting medium can be moved in relation to the material or a stationary environment. The focus position of the blasting medium remains constant in relation to the material.

In particular, at least during step b), the material is moved by the conveying device relative to the blasting medium along the circular path or transversely thereto.

In particular, during step b) the focus position of the blasting medium is moved at least along the circular path and additionally transversely to the course of the circular path by a movement of the blasting medium source or the deflecting means.

In particular, the processing device comprises the deflecting means and the deflecting means has the shape of a pyramid. During step b), the focus position of the blasting medium is moved at least along the circular path by rotating the deflecting means, wherein a speed of the focus position is greater than a feed speed of the material in the conveying device as a result of a rotational speed of the deflecting means.

In particular, the focus position can be moved back after reaching an end position, so for example when reaching an end point of a cutting line, to a starting position, so for example a starting point of a cutting line, wherein the starting position and the end position always remain the same in successive machining processes and for example cannot be moved with respect to the conveying device.

If the rotation speed is selected to be significantly higher, the same region of the material can be processed in several overruns, i.e. the focus position is repeatedly moved over the same region. This can, if necessary, increase the quality of the cut or reduce thermal stress on the material.

The method can in particular be carried out by a control device which is equipped, configured or programmed to carry out the described method.

Furthermore, the method can also be carried out by a computer or with a processor of a control unit.

Accordingly, a system for data processing is also proposed which comprises a processor which is adapted/configured in such a way that it carries out the method or some of the steps, in particular step b), of the proposed method.

A computer-readable storage medium can be provided which comprises commands which, when executed by a computer/processor, cause the latter to execute the method or at least some of the steps, in particular step b), of the proposed method.

The statements relating to the processing device are transferable, in particular, to the method and the computer-implemented method (that is to say the computer or the processor, the data processing system, the computer-readable storage medium) and vice versa.

The use of indefinite articles (“a” and “an”), in particular in the claims and the description reproducing them, is to be understood as such and not as a numeral. Correspondingly, the terms or components thus introduced are to be understood in such a way that they are present at least once and, in particular, can also be present several times.

As a precaution, it should be noted that the numerals used here (“first,” “second,” . . . ) serve primarily (only) to differentiate between a plurality of similar objects, sizes or processes, and in particular, therefore, do not necessarily prescribe any dependency and/or sequence of these objects, sizes or processes relative to one another. Should a dependency and/or sequence be necessary, this is explicitly stated here or it is evident for the person skilled in the art to study the specifically described configuration. If a component can occur more than once (“at least one”), the description of one of these components can apply equally to all or part of the majority of these components, but this is not mandatory.

### BRIEF DESCRIPTION OF THE DRAWINGS

The invention and the technical environment are explained in more detail below with reference to the accompanying figures. It should be pointed out that the invention is not intended to be limited by the exemplary embodiments mentioned. In particular, unless explicitly stated otherwise, it is also possible to extract partial aspects of the facts explained in the figures and to combine them with other components and findings from the present description. In particular, it should be pointed out that the figures and in particular the proportions shown are only schematic. In the figures:

FIG. 1: shows a first embodiment variant of a processing device in a side view and a detailed view along an axis of rotation;

FIG. 2: shows the detailed view according to FIG. 2 with the deflecting means in a starting position;

FIG. 3: shows the detailed view according to FIGS. 1 and 2 with the deflecting means in a first intermediate position;

FIG. 4: shows the detailed view according to FIG. 1 to 3 with the deflecting means in a second intermediate position;

FIG. 5: shows the detailed view according to FIG. 1 to 4 with the deflecting means in a third intermediate position;

FIG. 6: shows the detailed view according to FIG. 1 to 5 with the deflecting means in an end position;

FIG. 7: shows a second embodiment variant of a processing device in a side view; and

FIG. 8: shows a detailed view of FIG. 7 in a view along an axis of rotation.

### DETAILED DESCRIPTION OF THE INVENTION

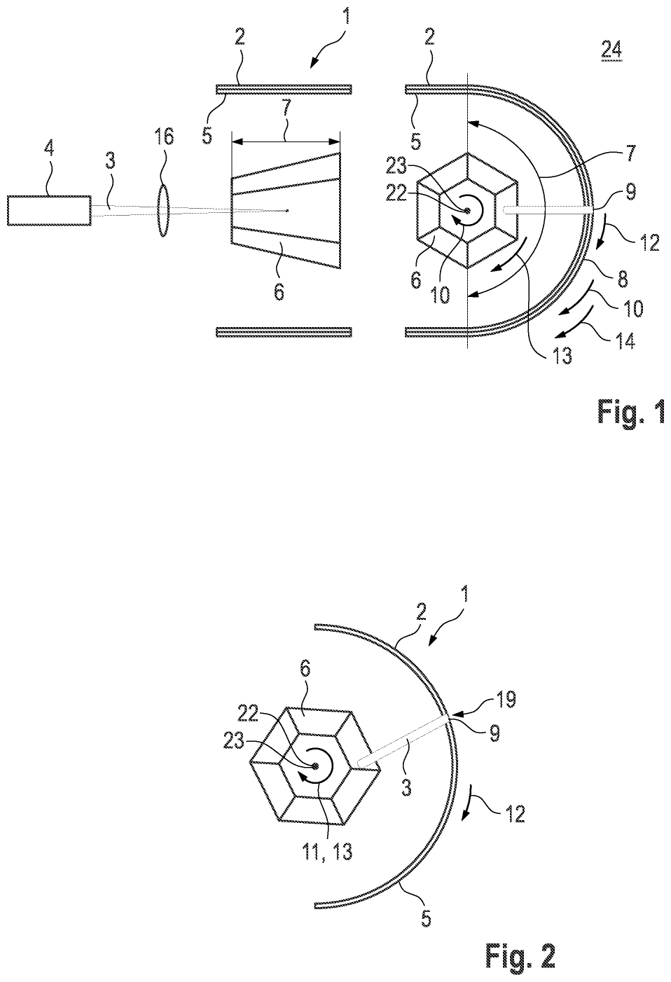

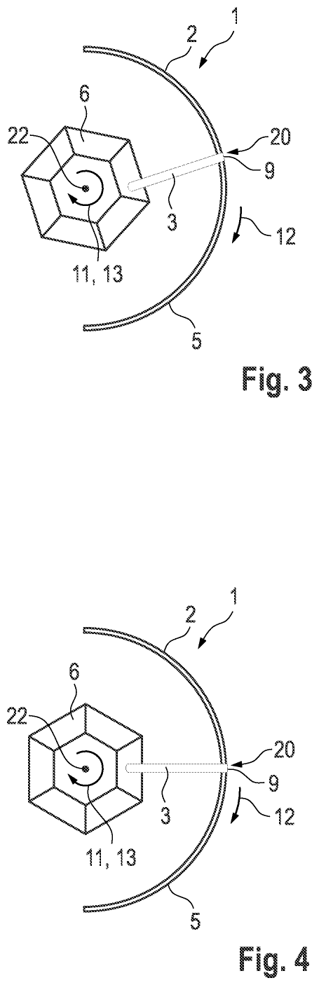

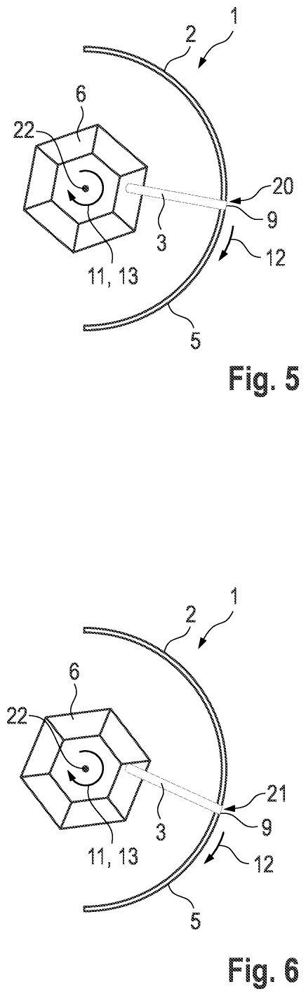

FIG. 1 shows a first embodiment variant of a processing device 1 in a side view and a detailed view in a view along an axis of rotation 22. FIG. 2 shows the detailed view according to FIG. 2 with the deflecting means 6 in a starting position 19. FIG. 3 shows the detailed view according to FIGS. 1 and 2 with the deflecting means 6 in a first intermediate position 20. FIG. 4 shows the detailed view according to FIG. 1 to 3 with the deflecting means 6 in a second intermediate position 20. FIG. 5 shows the detailed view according to FIG. 1 to 4 with the deflecting means 6 in a third intermediate position 20. FIG. 6 shows the detailed view according to FIG. 1 to 5 with the deflecting means 6 in an end position 21. FIG. 1 to 6 are described together below.

The processing device 1 comprises a blasting medium source 4 for generating the blasting medium 3 and a conveying device 5 for the material 2. In addition, the processing device 1 comprises a deflecting means 6 for deflecting the blasting medium 3 emitted by the blasting medium source 4 toward the material 2. If no deflecting means 6 is provided, the blasting medium source 4 can replace the deflecting means 6 in the figures shown.

The conveying device 5 is arranged opposite the deflecting means 6 in such a way that the material 2, at least with a region 7 to be processed by the blasting medium 3, is arranged on a circular path 8 by the conveying device 5 opposite the deflecting means 6. Thus, when the deflecting means 6 moves along the circular path 8, the material 2 can be processed with a constant focus position 9 of the blasting medium 3.

The blasting medium 3 is a laser beam. The blasting medium 3 has a focus position 9 for processing the material 2, that is to say a predetermined position of the focus with respect to the material 2. A focusing of the blasting medium 3 takes place in the laser beam, for example by optical focusing, e.g. through a focus lens 16.

The blasting medium 3 emerges from the blasting medium source 4 and strikes the material 2. A focusing in the form of a focus lens 16 and a deflecting means 6 are arranged between the blasting medium source 4 and the material 2. The deflecting means 6 serves to deflect the blasting medium 3 toward the material 2. The focus lens 16 is arranged in a stationary manner in the processing device 1.

The material 2 is to be processed in a predetermined region 7 along a line. This region 7 is arranged on a circular path 8 opposite the deflecting means 6. The circular path 8 has a center point 23, from which the material 2 is arranged along the region 7 at a constant distance or radius. The arrangement of the material 2 on a circular path 8 enables the blasting medium 3 to have a constant focus position 9 compared to the material 2 when the deflecting medium 6 rotates 11 about the center 23 of the circular path 8 or about the axis of rotation 22 of the deflecting means 6.

The conveying device 5 forms an arcuate support for the material 2. The material 2 can be moved by the conveying device 5 along a conveying direction 10 with respect to the deflecting means 6 or a stationary environment 24.

The material 2 can be held in a constant position during processing, i.e. when the blasting medium 3 is coupled into the material 2, and can only be moved during breaks in processing, i.e. when the blasting medium 3 is not coupled into the material 2, at a feed rate 14 compared to the deflecting means 6 or a stationary environment 24. As an alternative or in addition, the material 2 can also be moved during the processing with respect to the deflecting means 6 or a stationary environment 24 at a feed rate 14. In both cases, the blasting medium 3 can be moved relative to the material 2 or a stationary environment 24. The focus position 9 of the blasting medium 3 remains constant with respect to the material 2.

The conveying direction 10 of the material 2 can run along the circular path 8 or transversely to the course of the circular path 8.

By moving the deflecting means 6, the focus position 9 of the blasting medium 3 can be moved at least along the circular path 8. The movement along the circular path 8 is realized by a rotation 11 of the deflecting means 6.

The deflecting means 6 has a polygonal shape or a pyramid shape. The deflecting means 6 is arranged to be rotatable about an axis of rotation 22. When the deflecting means 6 is rotated 11 about an axis of rotation 22 which intersects the center point 23 of the circular path 8, the focus position 9 can be moved along the circular path 8 with the blasting medium source 4 in a constant position.

During the processing of the material 2, the focus position 9 of the blasting medium 3 can be moved along the circular path 8 by a rotation 11 of the deflecting means 6, wherein a speed of the focus position 9 due to a rotational speed 13 of the deflecting means 6 preferably is greater than a feed speed 14 of the material 2 in the conveying direction 10.

This means that the focus position 9 can be moved back to a starting position 19 (see FIG. 2, e.g. a starting point of a cutting line) after reaching an end position 21 (see FIG. 6, e.g. when an end point of a cutting line is reached), wherein the starting position 19 and the end position 21 always remain the same in successive machining processes and cannot be moved for example relative to the conveying device 5.

If the rotational speed 13 is selected to be significantly higher, the same region 7 of the material 2 can be processed in several overruns, i.e. the focus position 9 is repeatedly moved over the same region 7. In this way, the quality of the cut can possibly be increased or a thermal load on the material 2 can be reduced.

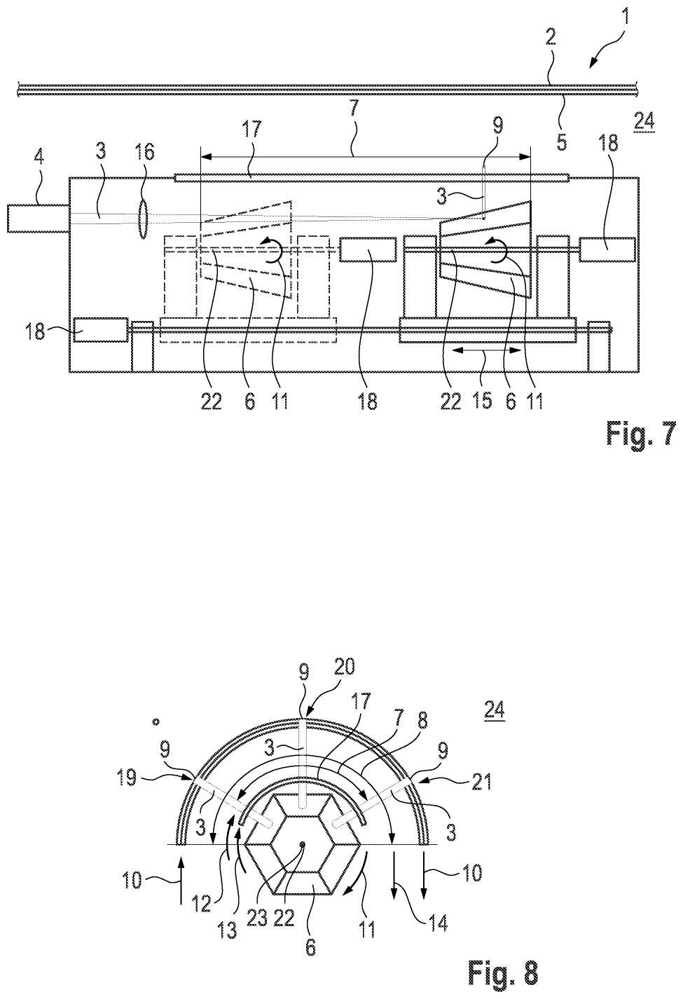

FIG. 7 shows a second embodiment variant of a processing device 1 in a side view. FIG. 8 shows a detailed view of FIG. 7 in a view along an axis of rotation 22. FIG. 7 to 8 are described together below. Reference is made to the statements on the FIGS. 1 to 6.

The processing device 1 comprises a blasting medium source 4 for generating the blasting medium 3 and a conveying device 5 for the material 2. In addition, the processing device 1 comprises a deflecting means 6 for deflecting the blasting medium 3 emitted by the blasting medium source 4 toward the material 2.

The deflecting means 6 can perform a transverse movement 15 along a transverse direction (see the two positions of the deflecting means 6 shown). Furthermore, the deflecting means 6 can execute a rotation 11 about the axis of rotation 22. By moving the deflecting means 6, the focus position 9 of the blasting medium 3 can be moved along the circular path 8 (see FIG. 8) and additionally transversely to the course of the circular path 8 (see FIG. 7). The movement along the circular path 8 is realized by a rotation 11 of the deflecting means 6. The movement transverse to the course of the circular path 8 is realized by a transverse movement 15 of the deflecting means 6. The movements along the circular path 8 and transversely to the course of the circular path 8 are coupled to one another and can therefore be carried out at least partially at the same time.

In this way, even when the material 2 is moved along a conveying direction 10 during processing, cut edges which run transversely to the conveying direction 10 can be generated.

The deflecting means 6 is moved via different motors 18. A protective glass 17 is

arranged between the material 2 and the deflecting means 6 and also extends in the

shape of a circular arc around the center point 23 or the axis of rotation 22.

In FIG. 8, a starting position 19, the intermediate positions 20, and the end position 21 of the blasting medium 3 are shown. To reach the different positions 19, 20, 21, the deflecting means 6 rotates 11 about the axis of rotation 22 of the deflecting means 6 or about the center point 23 of the circular path 8.

### LIST OF REFERENCE SIGNS

1 Processing device

2 Material

3 Blasting medium

4 Blasting medium source

5 Conveying device

6 Deflecting means

7 Region

8 Circular path

9 Focus position

10 Conveying direction

11 Rotation

12 Speed

13 Rotational speed

14 Feed rate

15 Transverse movement

16 Focus lens

17 Protective glass

18 Motor

19 Starting position

20 Intermediate position

21 End position

22 Axis of rotation

23 Midpoint

24 Environment

1. A processing device for processing a material with a focused blasting medium, comprising:
a blasting medium source for generating the blasting medium, and
a conveying device for the material, or additionally a deflecting means for deflecting the blasting medium emitted by the blasting medium source toward the material;
wherein the conveying device is arranged opposite the blasting medium source or the deflecting means in such a way that the material, at least with a region to be processed by the blasting medium, can be processed by the conveying device on a circular path opposite to the blasting medium source or to the deflecting means, so that the material, when the blasting medium source or the deflecting means is moved, can be processed along the circular path with a constant focus position of the blasting medium.

2. The processing device according to claim 1, wherein the material is configured to be moved by the conveying device along a conveying direction relative to the blasting medium source or the deflecting means.

3. The processing device according to claim 2, wherein the conveying direction runs along the circular path or transversely to the course of the circular path.

4. The processing device according to claim 1, wherein, through a movement of the blasting medium source or of the deflecting means, the focus position of the blasting medium is movable at least along the circular path and additionally transversely to the course of the circular path\.

5. The processing device according to claim 1, wherein the blasting medium is a laser beam.

6. The processing device according to claim 1,
wherein the processing device comprises the deflecting means, and
wherein the deflecting means has a pyramid shape.

7. A method for processing a material with a focused blasting medium in a processing device which has at least one blasting medium source for generating the blasting medium and a conveying device for the material, or additionally comprises a deflecting means for deflecting the blasting medium emitted by the blasting medium source toward the material; wherein the conveying device is arranged opposite the blasting medium source or the deflecting means so that the material, at least with a region to be processed by the blasting medium, is arranged by the conveying device on a circular path opposite the blasting medium source or the deflecting means; wherein the method comprises at least the following steps:
a) placing the material in the conveying device; and
b) processing of the material with the blasting medium, wherein the material is processed along the circular path with a constant focus position of the blasting medium.

8. The method according to claim 6, wherein the material is configured to be moved by the conveying device relative to the blasting medium along the circular path or transversely thereto at least during step b).

9. The method according to claim 7, wherein, during step b), the focus position of the blasting medium is moved by a movement of the blasting medium source or of the deflecting means at least along the circular path and additionally transversely to the course of the circular path.

10. The method according to claim 7,
wherein the processing device comprises the deflecting means,
wherein the deflecting means has a pyramid shape,
wherein, during step b), by rotation of the deflecting means, the focus position of the blasting medium is moved at least along the circular path, and
wherein a speed of the focus position is greater than a feed speed of the material in the conveying device as a result of a rotational speed of the deflecting means.
